(19) United States
(12) Patent Application Publication
(10) Pub. No.: US 2024/0385444 A1
(43) Pub. Date: Nov. 21, 2024

(54) SINGLE WAVEGUIDE RED-GREEN-BLUE (RGB) ARCHITECTURE USING LOW INDEX MEDIUMS

(71) Applicant: GOOGLE LLC, Mountain View, CA (US)

(72) Inventors: Eliezer Glik, San Diego, CA (US); Ruoping Li, Montreal (CA); Ido Raveh, Waterloo (CA)

(21) Appl. No.: 18/684,806

(22) PCT Filed: Aug. 10, 2022
(86) PCT No.: PCT/US2022/039907

§ 371 Date: Feb. 19, 2024

Related U.S. Application Data
(60) Provisional application No. 63/235,296, filed on Aug. 20, 2021.

(51) Int. Cl. G02B 27/01; F21V 8/00

(52) U.S. Cl. CPC G02B 27/0172; G02B 6/0016; G02B 6/0036; G02B 2027/0112; G02B 2027/0125; G02B 2027/0178

(57) ABSTRACT

A virtual image is displayed to a user via a light engine (211) to generate a display light representing the virtual image, a diffractive waveguide (235), and an incoupler (231) and outcoupler (234) that are each optically coupled to the diffractive waveguide (235). In operation, the incoupler (231) receives the display light from the light engine (211) and directs the received display light into the diffractive waveguide (235) and to one or more multidimensional intermediate gratings (232. 233). The multidimensional intermediate gratings (232, 233) redirect the display light through the diffractive waveguide (235) to the outcoupler (234), which in turn redirects at least a portion of the display light out of the diffractive waveguide (235) to an eye (291, 293) of the user.

### BACKGROUND

The present disclosure relates generally to augmented reality (AR) eyewear, which fuses a view of the real world with a heads-up display overlay. Wearable heads-up displays (WHUDs) are wearable electronic devices that use optical combiners to combine real world and virtual images. The optical combiner may be integrated with one or more lenses to provide a combiner lens that may be fitted into a support frame of a WHUD. In operation, the combiner lens provides a virtual display that is viewable by a user when the WHUD is worn on the head of the user.

One class of optical combiner uses one or more waveguides (also termed lightguides) to transfer light. In general, light from a projector, micro-display, or other light engine of the WHUD enters a waveguide of the combiner through an incoupler, propagates along the waveguide via total internal reflection (TIR), and exits the waveguide through an outcoupler. If a pupil of a user's eye is aligned with one or more exit pupils provided by the outcoupler, at least a portion of the light exiting through the outcoupler will enter the pupil of the user's eye, thereby enabling the user to see a virtual image. Since the optical combiner is substantially transparent, the user will also be able to see the real world.

### BRIEF SUMMARY OF EMBODIMENTS

Embodiments are described herein in which a virtual image is displayed to a user via a light engine to generate a display light representing the virtual image, a diffractive waveguide, and an incoupler and outcoupler that are each optically coupled to the diffractive waveguide. In operation, the incoupler receives the display light from the light engine and directs the received display light into the diffractive waveguide and to one or more intermediate multidimensional gratings. The intermediate multidimensional grating(s) redirect the display light through the diffractive waveguide to the outcoupler, which in turn redirects at least a portion of the display light out of the diffractive waveguide to an eye of the user.

In certain embodiments, a device comprises a light engine to generate red, green, and blue (RGB) display light; and a waveguide to direct the RGB display light to an eye of a user. The waveguide comprises an optical substrate; an incoupler grating to receive the RGB display light from the light engine and to direct the RGB display light into the waveguide; an outcoupler grating to direct at least some of the RGB display light from the waveguide to the eye of the user; and one or more intermediate gratings to direct one or more portions of the RGB display light from the incoupler grating to the outcoupler grating.

The one or more intermediate gratings may include multiple intermediate gratings, such that to direct the RGB display light into the waveguide includes to direct a first portion of the RGB display light from the light engine to a first intermediate grating of the multiple intermediate gratings and to direct a second portion of the RGB display light to a second intermediate grating of the multiple intermediate gratings.

The incoupler grating and the one or more intermediate gratings may direct red components of the RGB display light along a first path to the outcoupler grating and direct green and blue components of the RGB display light along a second path to the outcoupler grating.

Each of the intermediate gratings may be a multidimensional grating that comprises two or more sets of substantially parallel structures formed in a portion of the optical substrate.

At least one of the outcoupler grating and the incoupler grating may be a multidimensional grating, such that each multidimensional grating comprises two or more sets of substantially parallel structures formed in a portion of the optical substrate.

The optical substrate may have a refractive index of 1.6 or less.

In one embodiment, a method comprises receiving red, green, and blue (RGB) display light at an incoupler grating of a waveguide; directing the RGB display light from the incoupler grating to one or more intermediate gratings of the waveguide; directing the RGB display light, via the one or more intermediate gratings, to an outcoupler grating of the waveguide; and directing at least some of the RGB display light from the outcoupler grating to an eye of a user.

In at least one embodiment, a non-transitory computer-readable medium embodies a set of executable instructions, the set of executable instructions to manipulate a computer system to perform a portion of a process to fabricate at least part of a waveguide, such that the waveguide comprises an optical substrate; an incoupler grating to receive the RGB display light from the light engine and to direct the RGB display light into the waveguide; an outcoupler grating to direct at least some of the RGB display light from the waveguide to the eye of the user; and one or more intermediate gratings to direct one or more portions of the RGB display light from the incoupler grating to the outcoupler grating.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates an example wearable display device in accordance with some embodiments.

FIG. 2 illustrates a diagram of a wearable display device in accordance with some embodiments.

FIG. 3 illustrates a representational frontal view of an example high-index (n=2) diffractive waveguide.

FIG. 4 illustrates a k-space diagram of component wavelengths of an RGB display light traveling through the high-index diffractive waveguide of FIG. 3.

FIG. 5 illustrates a representational frontal view of an example low-index (n=1.5) diffractive waveguide in accordance with some embodiments.

FIG. 6 illustrates a k-space diagram of component wavelengths of an RGB display light traveling through the low-index diffractive waveguide of FIG. 5, in accordance with some embodiments.

FIG. 7 depicts an example method by which RGB display light may be directed to an eye of a user via a low-index diffractive waveguide in accordance with some embodiments.

### DETAILED DESCRIPTION

Some display devices employ multiple waveguides (also termed lightguides) to guide display light to a user's eye. For example, WHUD devices employ waveguides to guide light from a light engine to the user's eye. Some conventional architectures for waveguides employ diffractive optical elements. These architectures utilize separate waveguides for each of the visible colors, separating blue, green, and red light into their own waveguides. However, incorporating multiple distinct waveguides generally corresponds to larger and heavier devices, which is generally unfavorable for wearable devices.

For a waveguide display system, the field of view (FOV) provided for the wavelengths being directed by the system is a key parameter for evaluating its optical specifications. Factors that influence the angular magnitude of a provided FOV (with greater angular magnitudes being more desirable) include a refractive index of the waveguide material and the wavelength spectrum being directed.

Some waveguide architectures are able to direct all wavelengths—that is, all of the red, green, and blue (RGB) components of an RGB display light—via a single waveguide by employing materials with a high refractive index (e.g., a refractive index of n=2). However, using such a high-index medium typically involves relatively expensive and heavy glass, makes nano-imprint lithography (NIL) replication and other surface relief grating (SRG) processing difficult and expensive, and may result in an inability to utilize other diffractive technologies (e.g., volumetric holographic gratings (Bragg gratings)) that use materials (e.g., polycarbonate materials, regular glass, etc.) with a lower refractive index (such as a refractive index of n=1.6 or less). In contrast, waveguides formed from materials with such a low refractive index have been limited in their ability to direct all RGB components of an RGB display light into an exit pupil with an appropriate FOV. Previous approaches have worked around such limitations by, for example, utilizing multiple monochromatic or other wavelength-limited waveguides to direct an RGB display light, or utilizing a monochromatic or other wavelength-limited light engine.

Embodiments of techniques presented herein provide for a single waveguide comprising an optical substrate having a relatively low refractive index (n=1.6 or less) that directs substantially all wavelengths of an RGB display light to an eye of a user via an incoupler optical grating (with grating and optical grating being used interchangeably herein), an outcoupler (such as an outcoupler grating), and one or more intermediate gratings. For example, in certain embodiments the RGB display light is directed via such gratings along multiple wavelength-differentiated paths within a total internal reflection (TIR) volume of the waveguide, with the incoupler grating and a first intermediate grating operating to direct red component wavelengths of the RGB display light to the outcoupler, and the incoupler grating and a second intermediate grating operating to direct green and blue component wavelengths of the RGB display light to the outcoupler. By using multidimensional optical gratings to direct different wavelength components of an incoming RGB display light along different paths within a volume of the waveguide, embodiments allow all of those wavelength components to be accommodated within the refractive space provided by the relatively low-index (e.g., n=1.5) diffractive waveguide.

As used herein, a grating may be an etched or other surface grating, a volumetric holographic grating (VHG or Bragg grating), a polarization VHG, or other diffractive grating formed in the optical substrate and/or in one or more optical coatings thereof. In certain embodiments, each of the intermediate gratings and at least one of the incoupler grating and outcoupler grating comprise a multidimensional grating that includes two or more sets of substantially parallel structures (e.g., trenches, troughs, or other structures) formed in a portion of the optical substrate. In operation, each set of those multiple substantially parallel structures acts as a one-dimensional grating to direct a specific portion—e.g., a subset of wavelength components—of any RGB display light received at the multidimensional grating. In certain embodiments and scenarios, a two-dimensional grating may comprise a first single-dimensional (1D) grating formed in one portion of the optical substrate and a second 1D grating formed in another overlapping portion of the optical substrate—for example, on opposing sides of a substrate layer.

It will be appreciated that while particular embodiments discussed herein involve utilizing optical or other components as part of a wearable display device, additional embodiments may utilize such components via various other types of devices in accordance with techniques described herein.

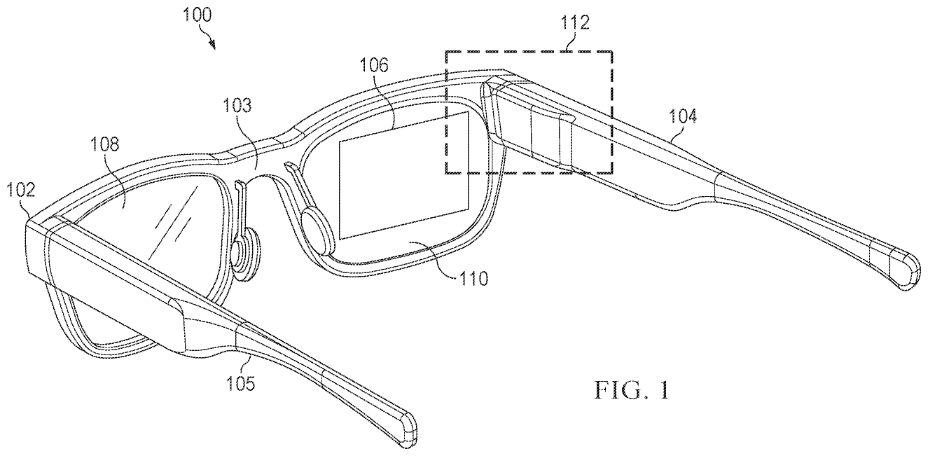

FIG. 1 illustrates an example wearable display device 100 in accordance with various embodiments. In the depicted embodiment, the wearable display device 100 is a near-eye display system having a general shape and appearance (that is, form factor) of an eyeglasses (e.g., sunglasses) frame. The wearable display device 100 includes a support structure 102 that includes a first arm 104, a second arm 105, and a front frame 103, which is physically coupled to the first arm 104 and the second arm 105. When worn by a user, the first arm 104 may be positioned on a first side of a head of the user, while the second arm 105 may be positioned on a second side of the head of the user opposite to the first side of the head of the user, and the front frame 103 may be positioned on a front side of the head of the user. In the depicted embodiment, the support structure 102 houses a light engine (e.g., a laser projector, a micro-LED projector, a Liquid Crystal on Silicon (LCOS) projector, or the like) that is configured to project images toward the eye of a user via a waveguide. The user perceives the projected images as being displayed in a field of view (FOV) area 106 of a display at one or both of lens structures 108, 110 via one or more optical display elements of the wearable display device 100.

The support structure 102 contains or otherwise includes various components to facilitate the projection of such images toward the eye of the user, such as a light engine and a waveguide. In some embodiments, the support structure 102 further includes various sensors, such as one or more front-facing cameras, rear-facing cameras, other light sensors, motion sensors, accelerometers, and the like. In some embodiments, the support structure 102 includes one or more radio frequency (RF) interfaces or other wireless interfaces, such as a Bluetooth™ interface, a WiFi interface, and the like. Further, in some embodiments, the support structure 102 further includes one or more batteries or other portable power sources for supplying power to the electrical components of the wearable display device 100. In some embodiments, some or all of these components of the wearable display device 100 are fully or partially contained within an inner volume of support structure 102, such as within the first arm 104 in region 112 of the support structure 102. It should be noted that while an example form factor is depicted, it will be appreciated that in other embodiments the wearable display device 100 may have a different shape and appearance from the eyeglasses frame depicted in FIG. 1. It should be understood that instances of the term “or” herein refer to the non-exclusive definition of “or”, unless noted otherwise. For example, herein the phrase “X or Y” means “either X, or Y, or both”.

One or both of the lens structures 108, 110 are used by the wearable display device 100 to provide an augmented reality (AR) display in which rendered graphical content can be superimposed over or otherwise provided in conjunction with a real-world view as perceived by the user through the lens structures 108, 110. For example, a projection system of the wearable display device 100 uses light to form a perceptible image or series of images by projecting the light onto the eye of the user via a light engine of the projection system, a waveguide formed at least partially in the corresponding lens structure 108 or 110, and one or more optical display elements, according to various embodiments. In various embodiments, the optical display elements of the wearable display device 100 include one or more instances of optical components selected from a group that includes at least: a waveguide (references to which, as used herein, include and encompass both light guides and waveguides), holographic optical element, prism, diffraction grating, light reflector, light reflector array, light refractor, light refractor array, collimation lens, scan mirror, optical relay, or any other light-redirection technology as appropriate for a given application, positioned and oriented to redirect AR content from the light engine towards the eye of the user. Moreover, some or all of the lens structures 108, 110 and optical display elements may individually and/or collectively comprise an optical substrate in which one or more structures may be formed. For example, the optical display elements may include various optical gratings (whether as an incoupler grating, outcoupler grating, or intermediate grating) formed in an optical substrate material of the lens structures 108, 110.

One or both of the lens structures 108, 110 includes at least a portion of a waveguide that routes display light received by an incoupler of the waveguide to an outcoupler of the waveguide, which outputs the display light toward an eye of a user of the wearable display device 100. The display light is modulated and projected onto the eye of the user such that the user perceives the display light as an image. In addition, each of the lens structures 108, 110 is sufficiently transparent to allow a user to see through the lens structures to provide a field of view of the user's real-world environment such that the image appears superimposed over at least a portion of the real-world environment.

The lens structure 135 may include multiple lens layers, each of which may be disposed closer to an eye of the user than one or more optical display elements (eye side) or further from the eye of the user than one or more optical display elements (world side). A lens layer can, for example, be molded or cast, may include a thin film or coating, and may include one or more transparent carriers, which as described herein may refer to a material which acts to carry or support an optical redirector. As one example, a transparent carrier may be an eyeglasses lens or lens assembly. In addition, in certain embodiments one or more of the lens layers may be implemented as a contact lens.

In some embodiments, the light engine of the projection system of the display 100 is a digital light processing-based projector, a scanning laser projector, or any combination of a modulative light source, such as a laser or one or more light-emitting diodes (LEDs), and a dynamic reflector mechanism such as one or more dynamic scanners, reflective panels, or digital light processors (DLPs). In some embodiments, the light engine includes a micro-display panel, such as a micro-LED display panel (e.g., a micro-AMOLED display panel, or a micro inorganic LED (i-LED) display panel) or a micro-Liquid Crystal Display (LCD) display panel (e.g., a Low Temperature PolySilicon (LTPS) LCD display panel, a High Temperature PolySilicon (HTPS) LCD display panel, or an In-Plane Switching (IPS) LCD display panel). In some embodiments, the light engine includes a Liquid Crystal on Silicon (LCOS) display panel. In some embodiments, a display panel of the light engine is configured to output light (representing an image or portion of an image for display) into the waveguide of the display system. The waveguide expands the light and outputs the light toward the eye of the user via an outcoupler.

The light engine is communicatively coupled to the controller and a non-transitory processor-readable storage medium or memory storing processor-executable instructions and other data that, when executed by the controller, cause the controller to control the operation of the light engine. In some embodiments, the controller controls the light engine to selectively set the location and size of the FOV area 106. In some embodiments, the controller is communicatively coupled to one or more processors (not shown) that generate content to be displayed at the wearable display device 100. The light engine outputs light toward the FOV area 106 of the wearable display device 100 via the waveguide. In some embodiments, at least a portion of an outcoupler of the waveguide overlaps the FOV area 106.

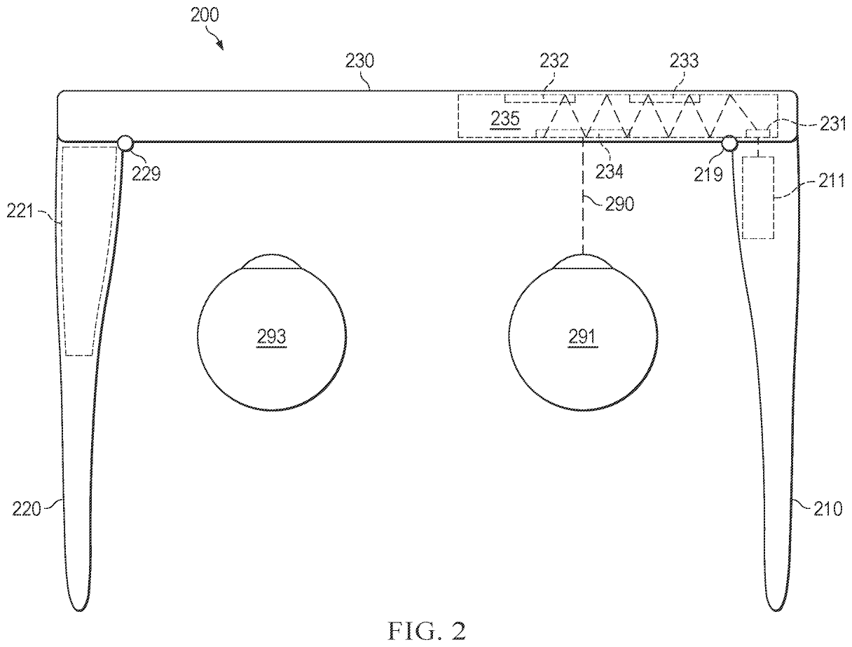

FIG. 2 illustrates a diagram of a wearable display device 200 in accordance with some embodiments. In some embodiments, the wearable display device 200 may implement or be implemented by aspects of the wearable display device 100. For example, in the depicted embodiment the wearable display device 200 includes a first arm 210, a second arm 220, and a front frame 230. The first arm 210 is coupled to the front frame 230 by a hinge 219, which allows the first arm 210 to rotate relative to the front frame 230. The second arm 220 is coupled to the front frame 230 by the hinge 229, which allows the second arm 220 to rotate relative to the front frame 230.

In the example of FIG. 2, the wearable display device 200 is in an unfolded configuration, in which the first arm 210 and the second arm 220 are rotated such that the wearable display device 200 can be worn on a head of a user, with the first arm 210 positioned on a first side of the head of the user, the second arm 220 positioned on a second side of the head of the user opposite the first side, and the front frame 230 positioned on a front of the head of the user. The first arm 210 and the second arm 220 can be rotated towards the front frame 230, until both the first arm 210 and the second arm 220 are approximately parallel to the front frame 230, such that the wearable display device 200 may be in a compact shape that fits conveniently in a rectangular, cylindrical, or oblong case. Alternatively, the first arm 210 and the second arm 220 may be fixedly mounted to the front frame 230, such that the wearable display device 200 cannot be folded.

In FIG. 2, the first arm 210 carries a light engine 211. The second arm 220 carries a power source 221. The front frame 230 carries a diffractive waveguide 235 that includes an incoupling optical grating (incoupler) 231, intermediate gratings 232 and 233, and an outcoupling optical grating (outcoupler) 234. At least one set of electrically conductive current paths (not shown) provides electrical coupling between the power source 221 and electrical components (such as the light engine 211) carried by the first arm 210. Such electrical coupling is provided indirectly, such as through a power supply circuit, or is provided directly from the power source 221 to each electrical component in the first arm 210. As used herein, the terms carry, carries or similar do not necessarily dictate that one component physically supports another component. For example, it is stated above that the first arm 210 carries the light engine 211. This could mean that the light engine 211 is mounted to or within the first arm 210, such that the first arm 210 physically supports the light engine 211. However, it could also describe a direct or indirect coupling relationship, even when the first arm 210 is not necessarily physically supporting the light engine 211.

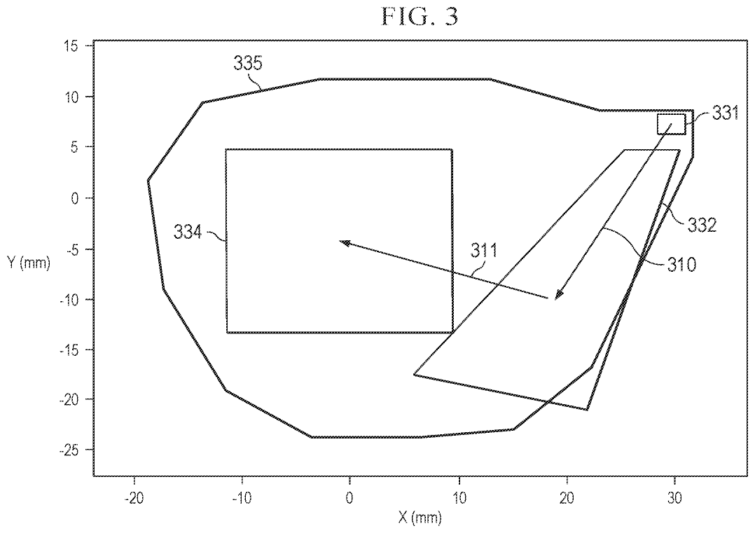

The light engine 211 can output a display light 290 (simplified for this example) representative of AR content or other display content to be viewed by a user. The display light 290 can be redirected by diffractive waveguide 235 towards an eye 291 of the user, such that the user can see the AR content. The display light 290 from the light engine 211 impinges on the incoupler 231 and is redirected to travel in a volume of the diffractive waveguide 235, where the display light 290 is directed through the diffractive waveguide 235 (e.g., by total internal reflection (TIR) or surface treatments such as holograms or reflective coatings). Subsequently, the display light 290 traveling in the volume of the diffractive waveguide 235 impinges on the intermediate gratings 232 and/or 233, which redirect the display light 290 to outcoupler 234, which further directs the display light 290 out of the diffractive waveguide 235 and towards the eye 291 of a user. It will be appreciated that while in the depicted embodiment, intermediate gratings 232 and 233 are depicted as surface gratings on a world-side surface of the diffractive waveguide 235, in various embodiments such intermediate gratings may be formed in other positions with respect to a volume of the diffractive waveguide 235 (such as on an eye-side surface of the waveguide, as a VHG within the volume, etc.). Additional details regarding the transmission path of display light through a volume of a diffractive waveguide (such as the diffractive waveguide 235) are discussed with respect to FIGS. 3-6 below.

The wearable display device 200 may include a processor (not shown) that is communicatively coupled to each of the electrical components in the wearable display device 200, including but not limited to the light engine 211. The processor can be any suitable component which can execute instructions or logic, including but not limited to a micro-controller, microprocessor, multi-core processor, integrated-circuit, ASIC, FPGA, programmable logic device, or any appropriate combination of these components. The wearable display device 200 can include a non-transitory processor-readable storage medium, which may store processor readable instructions thereon, which when executed by the processor can cause the processor to execute any number of functions, including causing the light engine 211 to output the light 290 representative of display content to be viewed by a user, receiving user input, managing user interfaces, generating display content to be presented to a user, receiving and managing data from any sensors carried by the wearable display device 200, receiving and processing external data and messages, and any other functions as appropriate for a given application. The non-transitory processor-readable storage medium can be any suitable component, which can store instructions, logic, or programs, including but not limited to non-volatile or volatile memory, read only memory (ROM), random access memory (RAM), FLASH memory, registers, magnetic hard disk, optical disk, or any combination of these components.

FIG. 3 illustrates a representational frontal view of an example high-index (n=2) diffractive waveguide 335, which in the depicted embodiment has a form factor approximating that of an eyeglass lens. The waveguide 335 comprises an optical substrate in which is formed multiple optical gratings to direct incoming RGB display light to an eye (not shown) of a user. In particular, the waveguide 335 includes an incoupler grating 331, a single two-dimensional intermediate grating 332, and an outcoupler grating 334.

In operation, an incoming RGB display light is received (such as from a proximate light engine, not shown) at the incoupler grating 331 and directed via the incoupler grating (such as along the depicted path 310) to the intermediate grating 332, which redirects the RGB display light (such as along the depicted path 311) to outcoupler grating 334, which redirects the RGB display light out of the diffractive waveguide 335 and into an eye of a user (not shown). It will be appreciated that the depicted paths 310 and 311 are provided to illustrate the general direction of travel taken by the redirected RGB display light, and are not intended to accurately depict the specific path of any particular component of that RGB display light.

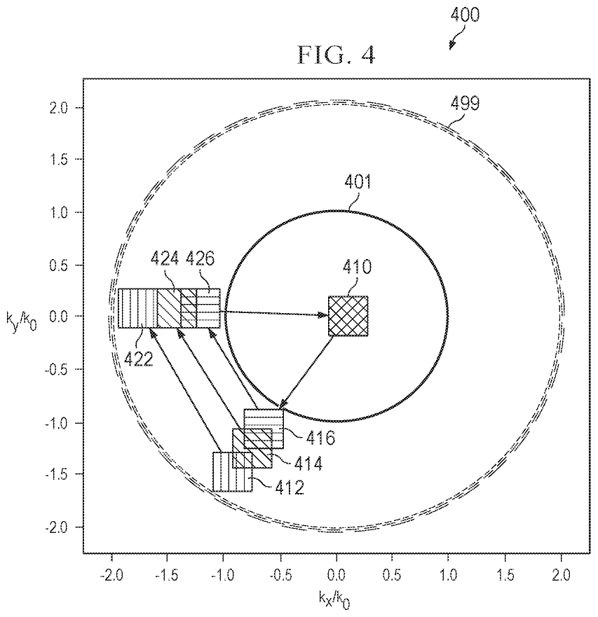

FIG. 4 illustrates a normalized k-space representation 400 of component wavelengths of an RGB display light traveling through the high-index diffractive waveguide 335 of FIG. 3. In the k-space representation 400 (with k being the reciprocal of wavelength, such that k=1/λ), an inner refractive boundary 401 is depicted as a circle with radius of n=1, the refractive index associated with the external transmission medium (air); outer refractive boundary 499 corresponds to a refractive index of n=2, the refractive index of diffractive waveguide 335 in FIG. 3.

In the context of the k-space representation 400, for RGB display light (e.g., full-color AR content) to be successfully and accurately directed to an eye of a user via a waveguide with the indicated refractive index (such as diffractive waveguide 335), each red, green, and blue component of that RGB display light enters the waveguide from an external position 410, which is included in the space depicted within inner refractive boundary 401. The components are directed along one or more paths within a volume of the waveguide (the space depicted between inner refractive boundary 401 and outer refractive boundary 499), and are then redirected to exit the waveguide (and thereby return to the external space within inner refractive boundary 401). Display light components represented between the inner refractive boundary 401 and outer refractive boundary 499 are propagated to the user via the waveguide. Any display light components represented outside the outer refractive boundary 499 (of which there are none in the k-space representation 400) are non-propagating, such as those that are either lost externally or comprise an imaginary component (such that it only appears in mathematic modeling of the display light component).

In operation, and with continuing reference to both FIG. 3 and FIG. 4, each RGB component of an RGB display light originating from refractive position 410 to be directed through diffractive waveguide 335 is provided to the volume of the diffractive waveguide via incoupler grating 331. In FIG. 4, the red display light component 412, green display light component 414, and blue display light component 416 are depicted as they reach and are redirected by the intermediate grating 332 (FIG. 3). As a result of that redirection, they reach outcoupler grating 334 in the refractive positions indicated as red display light component 422, green display light component 424, and blue display light component 426, which are redirected by the outcoupler grating to exit the diffractive waveguide 335 (as shown via the path back to originating refractive position 410).

Thus, the k-space representation 400 provides a view of each RGB component of an incoming RGB display light as it is directed through the diffractive waveguide 335. Notably, all of the RGB components are accommodated by the relatively large refractive space provided by the high-index diffractive waveguide 335 as they are directed through it, as indicated by the respective positions of those display light components 412, 414, 416, 422, 424, 426 between the inner refractive boundary 401 and outer refractive boundary 499.

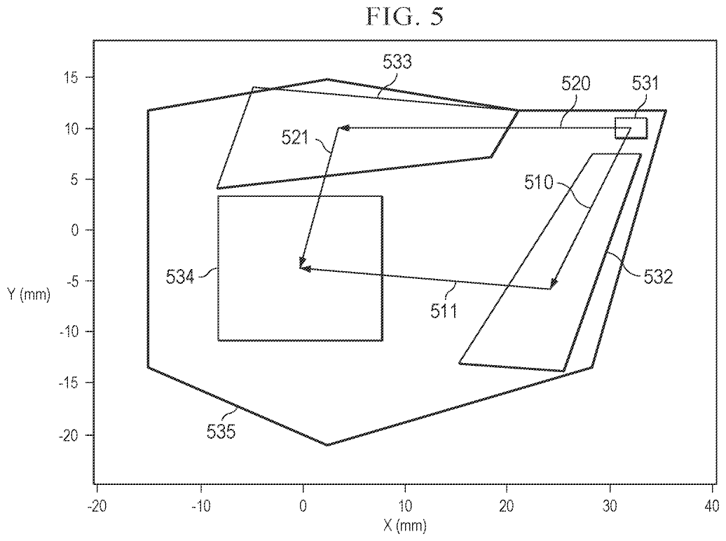

FIG. 5 illustrates a representational frontal view of an example low-index (n=1.5) diffractive waveguide 535, which in the depicted embodiment (and similar to diffractive waveguide 335 of FIG. 3) has a form factor approximating that of an eyeglass lens. In a manner similar to that described with respect to diffractive waveguide 335, diffractive waveguide 535 comprises an optical substrate, in which are formed multiple optical gratings to direct incoming RGB display light to an eye (not shown) of a user. In particular, the waveguide 535 includes an incoupler grating 531, a first two-dimensional intermediate grating 532, a second two-dimensional intermediate grating 533, and an outcoupler grating 534. As discussed elsewhere herein, two-dimensional gratings (in which are formed two sets of substantially parallel periodic structures, with each parallel set oriented in a separate direction) are distinct from traditional one-dimensional gratings (in which is formed a single set of substantially parallel periodic structures) in that they refract light in two different directions. Thus, a 2D optical grating such as intermediate grating 532 or intermediate grating 533, when formed at a surface of an optical substrate, has two sets of parallel troughs or trenches etched into the optical substrate, each at a different angle.

In at least the depicted embodiment, the incoupler grating 531 is also a two-dimensional grating, which allows the incoupler grating 531 to direct a first portion of the incoming RGB display light in a first direction (e.g., along indicated path 510) while directing a second portion of the RGB display light in a second direction (e.g., along indicated path 520). Here, the incoupler grating 531 is configured to direct red display light components of the received RGB display light along indicated path 510 to the intermediate grating 532, and configured to direct green and blue display light components of the received RGB display light along indicated path 520 to the intermediate grating 533. Intermediate grating 532 is configured to redirect the received red display light components to the outcoupler grating 534 along path 511. Similarly, intermediate grating 533 is configured to redirect the received green and blue display light components to the outcoupler grating 534 along path 521. The outcoupler grating 334 then redirects the RGB display light out of the diffractive waveguide 535 and into an eye of a user (not shown). In the depicted embodiment, the outcoupler grating 534 comprises a two-dimensional grating, such that it is configured to redirect display light components arriving from two different directions (e.g., from indicated path 511 and 521, respectively) to exit the diffractive waveguide 535 in a single direction—that is, towards the user's eye.

As with the depicted paths 310 and 311 of FIG. 3, it will be appreciated that the depicted paths 510, 511, 520, 521 are provided to illustrate the general direction of travel taken by various display light components of the directed RGB display light, and are not intended to accurately depict the specific path of any particular component of that RGB display light.

Thus, in operation, the incoupler grating 531 and the intermediate gratings 532 and 533 operate in combination to direct red components of the RGB display light along a first path (510, 511) to the outcoupler grating and to direct green and blue components of the RGB display light along a second path (520, 521) to the outcoupler grating 534.

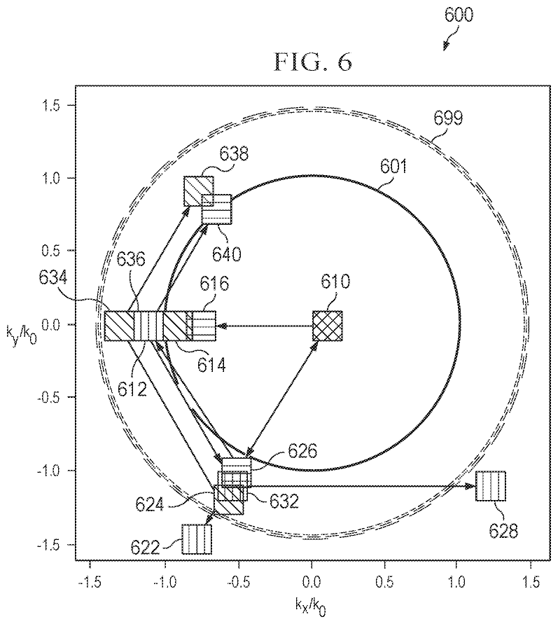

FIG. 6 illustrates a normalized k-space representation 600 of component wavelengths of an RGB display light traveling through the low-index diffractive waveguide 535 of FIG. 5. In the k-space representation 600, an inner refractive boundary 601 is depicted as a circle with radius of n=1, the refractive index of air; outer refractive boundary 499 corresponds to a refractive index of n=1.5, the relatively low refractive index of the optical substrate comprising diffractive waveguide 535. Therefore, in contrast to the normalized k-space representation 400 of FIG. 4, the refractive space available to accommodate display light components between the inner refractive boundary 601 and outer refractive boundary 699 is significantly narrower than the relatively large refractive space available between the respective refractive boundaries 401, 499.

In the context of the k-space representation 600, for RGB display light to be successfully and accurately directed to an eye of a user via a waveguide with the indicated refractive index (such as diffractive waveguide 535), each red, green, and blue component of that RGB display light enters the waveguide from an external position 610, which is included in the space depicted within inner refractive boundary 601. The components are directed along multiple paths within the volume of the waveguide (the space depicted between inner refractive boundary 601 and outer refractive boundary 699), and are then redirected to exit the waveguide to the external position 610 (representing travel to an exit pupil and thereby the eye of the user, not shown). In a manner similar to that described with respect to the refractive boundaries 401 and 499 of FIG. 4, display light components represented between the inner refractive boundary 601 and outer refractive boundary 699 are propagated to the user via the waveguide. Any display light components represented outside the outer refractive boundary 699 are non-propagating. As can be seen from the k-space representation 600, several such non-propagating display light components arise from use of the relatively low-index diffractive waveguide 535, as discussed below.

In operation, and with continuing reference to both FIG. 5 and FIG. 6, each RGB component of an RGB display light to be directed through diffractive waveguide 535 is provided from originating refractive position 610 to the volume of the diffractive waveguide via incoupler grating 531. However, as discussed above and in contrast to the scenario described with respect to the high-index diffractive waveguide 335, the two-dimensional incoupler grating 531 directs the received RGB display light in two separate directions, each of which corresponds to a separate set of substantially parallel structures (not shown) formed as part of the incoupler grating 531. In particular, a first set of substantially parallel structures of the incoupler grating 531 directs incoming RGB display light to a first set of refractive positions 612 (R), 614 (G), and 616 (B), with only the refractive position 612 for the red display light component being positioned within the volume of the diffractive waveguide 535. Because the refractive positions 614 and 616 are within the inner refractive boundary 601, the green and blue display light components directed to those refractive positions are effectively outcoupled (i.e., directed away) from the waveguide and are not successfully directed through the diffractive waveguide 535. The second set of substantially parallel structures of the incoupler grating 531 directs incoming RGB display light to a second set of refractive positions 622 (R), 624 (G), and 626 (B). Here, while refractive positions 644 and 626 indicate that the green and blue display light components redirected by the second set of substantially parallel structures of the incoupler grating 531 are successfully directed through the diffractive waveguide 535, the red display light components are directed to refractive position 622, which is outside the outer refractive boundary 699—indicating that such red display light components are non-propagating.

To summarize the operation so far, the RGB display light received by the two-dimensional incoupler grating 531 has been directed such that the red display light components successfully reach intermediate grating 532 at refractive position 612, and such that the green and blue display light components successfully reach intermediate grating 533 at refractive positions 624 and 626, respectively.

Again illustrated using the context of k-space representation 600, the two-dimensional intermediate grating 532 of FIG. 5 redirects the red display light components from the refractive position 612 to the outcoupler 534 at a refractive position 632; similarly, the two-dimensional intermediate grating 533 redirects the green and blue display light components from their respective refractive positions 624 and 626 to new respective refractive positions 634 and 636 at the outcoupler 534. As discussed above, because the outcoupler 534 is a two-dimensional grating, it is configured to receive display light components from two separate directions (corresponding to a first direction from which the red display light components are received at refractive position 632, and to a second direction from which the green and blue display light components are received at refractive positions 634 and 636), and to redirect the resulting RGB display light to exit the diffractive waveguide 535 (as shown via the path back to originating refractive position 610).

In the depicted embodiment, the relatively low refractive index of the diffractive waveguide 535 results in several incidental non-propagating losses of specific display light components. In particular, an imaginary portion of the red display light component from refractive position 632—the real components of which are redirected to advantageously exit the diffractive waveguide 535 towards an eye of a user—is shown as redirected to a new refractive position 628 that is outside the outer refractive boundary 699. More significantly, a small portion of the green and blue display light components are redirected by the outcoupler 534 from their respective refractive positions 634 and 636 to new refractive positions 638 and 640, respectively. As can be seen in the k-space representation 600, the display light components at those refractive positions do not successfully exit the waveguide; rather, they are susceptible to causing a minor ghosting effect with those wavelengths (green and blue) in a side of the provided FOV. However, these effects can be mitigated with efficiencies and eyebox positioning to avoid or diminish any negative impact to the resulting display.

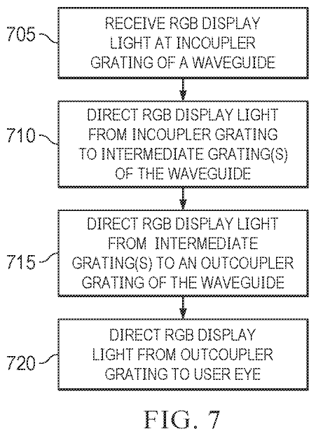

FIG. 7 depicts an example method by which RGB display light is directed to an eye of a user via a low-index diffractive waveguide (e.g., diffractive waveguide 535 of FIG. 5) in accordance with one or more embodiments.

The method begins at block 705, in which RGB display light is received at an incoupler grating (e.g., incoupler grating 531 of FIG. 5) of the waveguide.

At block 710, the RGB display light is directed from the incoupler grating to one or more intermediate gratings of the waveguide (e.g., intermediate gratings 532 and 533 of FIG. 5).

At block 715, the RGB display light is redirected via the one or more intermediate gratings to an outcoupler grating of the waveguide.

At block 720, at least some of the RGB display light is directed from the waveguide to an eye of a user via the outcoupler grating.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A device, comprising:
a waveguide to direct red, green, and blue (RGB) display light from a light engine to an eye of a user, the waveguide comprising:
an optical substrate;
an incoupler grating to receive the RGB display light from the light engine and to direct the RGB display light into the waveguide;
an outcoupler grating to direct at least some of the RGB display light from the waveguide to the eye of the user; and
one or more intermediate gratings to direct one or more portions of the RGB display light from the incoupler grating to the outcoupler grating.

2. The device of claim 1 wherein the one or more intermediate gratings include multiple intermediate gratings, and wherein to direct the RGB display light into the waveguide includes to direct a first portion of the RGB display light from the light engine to a first intermediate grating of the multiple intermediate gratings and to direct a second portion of the RGB display light to a second intermediate grating of the multiple intermediate gratings.

3. The device of claim 1, wherein the incoupler grating and the one or more intermediate gratings are to direct red components of the RGB display light along a first path to the outcoupler grating and to direct green and blue components of the RGB display light along a second path to the outcoupler grating.

4. The device of claim 3, wherein the one or more intermediate gratings include a first intermediate grating to direct the red components of the RGB display light along the first path and a second intermediate grating to direct the green and blue components of the RGB display light along the second path.

5. The device of claim 1, wherein each of the intermediate gratings is a multidimensional grating that comprises two or more sets of substantially parallel structures formed in a portion of the optical substrate.

6. The device of claim 5, wherein the optical substrate comprises one or more optical coatings, and wherein at least one of the one or more intermediate gratings is at least partially formed in at least one optical coating of the one or more optical coatings.

7. The device of claim 1, wherein at least one of the outcoupler grating and the incoupler grating is a multidimensional grating, and wherein each multidimensional grating comprises two or more sets of substantially parallel structures formed in a portion of the optical substrate.

8. The device of claim 1, wherein the optical substrate has a refractive index of 1.6 or less.

9. A method, comprising:
receiving red, green, and blue (RGB) display light at an incoupler grating of a waveguide;
directing the RGB display light from the incoupler grating to one or more intermediate gratings of the waveguide;
directing the RGB display light, via the one or more intermediate gratings, to an outcoupler grating of the waveguide; and
directing at least some of the RGB display light from the outcoupler grating to an eye of a user.

10. The method of claim 9 wherein directing the RGB display light to the one or more intermediate gratings includes directing a first portion of the RGB display light from a light engine to a first intermediate grating and to direct a second portion of the RGB display light from the light engine to a second intermediate grating.

11. The method of claim 10 wherein the first portion comprises red components of the RGB display light, and wherein the second portion comprises green and blue components of the RGB display light.

12. The method of claim 9, comprising directing red components of the RGB display light along a first path to the outcoupler grating and directing green and blue components of the RGB display light along a second path to the outcoupler grating.

13. The method of claim 9, wherein directing the RGB display light via the one or more intermediate gratings includes directing the RGB display light via one or more multidimensional gratings, each multidimensional grating comprising two or more sets of substantially parallel structures formed in an optical substrate of the waveguide.

14. The method of claim 9, wherein at least one of the outcoupler grating and the incoupler grating is a multidimensional grating.

15. The method of claim 9, wherein receiving the RGB display light at an incoupler grating of a waveguide includes receiving the RGB display light at an incoupler grating formed in an optical substrate having a refractive index of 1.6 or less.

16. A non-transitory computer-readable medium embodying a set of executable instructions, the set of executable instructions to manipulate a computer system to perform a portion of a process to fabricate at least part of a waveguide, the waveguide comprising:
an optical substrate;
an incoupler grating to receive red, green, and blue (RGB) display light from a light engine and to direct the RGB display light into the waveguide;
an outcoupler grating to direct at least some of the RGB display light from the waveguide to an eye of a user; and
one or more intermediate gratings to direct one or more portions of the RGB display light from the incoupler grating to the outcoupler grating.

17. The non-transitory computer-readable medium of claim 16, wherein the one or more intermediate gratings include multiple intermediate gratings, and wherein to direct the RGB display light into the waveguide includes to direct a first portion of the RGB display light from the light engine to a first intermediate grating of the multiple intermediate gratings and to direct a second portion of the RGB display light to a second intermediate grating of the multiple intermediate gratings.

18. The non-transitory computer-readable medium of claim 16, wherein the incoupler grating and the one or more intermediate gratings are to direct red components of the RGB display light along a first path to the outcoupler grating and to direct green and blue components of the RGB display light along a second path to the outcoupler grating.

19. The non-transitory computer-readable medium of claim 16, wherein each of the intermediate gratings is a multidimensional grating that comprises two or more sets of substantially parallel structures formed in a portion of the optical substrate.

20. The non-transitory computer-readable medium of claim 16, wherein the optical substrate has a refractive index of 1.6 or less.
